(19) United States
(12) Patent Application Publication
(10) Pub. No.: US 2003/0023983 A1
(43) Pub. Date: Jan. 30, 2003

(54) Cable television system with digital reverse path architecture

(76) Inventors: Rezin E. Pidgeon JR., Atlanta, GA (US); Douglas E. Brown, Lawrenceville, GA (US); Fariborz M. Farhan, Alpharetta, GA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 10/217,886

(22) Filed: Aug. 13, 2002

Related U.S. Application Data
(63) Continuation-in-part of application No. 09/283,498, filed on Apr. 1, 1999.

(51) Int. Cl. G02F 1/00; G02F 2/00; H01S 3/00; H04B 10/00; H04J 14/00; H04N 7/173; H04L 12/28; H04L 12/56

(52) U.S. Cl. 725/121; 725/127; 370/408; 359/109

(57) ABSTRACT

A communications system includes forward and reverse paths. Reverse path circuitry within an optical node of the system receives reverse analog electrical signals from subscriber equipment and generates therefrom a multiplexed reverse digital optical signal. A coupling node combines digital optical signals and/or RF signals from an optical node or from coaxial cable, respectively. The combined digital optical signal is transmitted over a fiber optic cable to a cable television hub, the reverse path portion of which includes no active circuitry. The hub multiplexes the digital optical signal with other digital optical signals from other nodes to generate one or more forwarded digital optical signals at a hub output, wherein generation of the one or more forwarded digital optical signals requires only passive devices in the reverse path of the hub. The hub is coupled to headend equipment by one or more fiber optic cables, and the headend equipment receives the one or more forwarded digital optical signals and recovers therefrom the reverse analog electrical signals provided by the optical node.

### RELATED APPLICATIONS

This application is a continuation-in-part of application Ser. No. 09/283,498 entitled “Cable Television System with Digital Reverse Path Architecture”, filed Apr. 1, 1999 in the names of Brown et al., commonly assigned with the present invention, the teachings of which are incorporated by reference.

### FIELD OF THE INVENTION

This invention relates generally to communication systems, and more specifically to communication systems having two-way digital communication capability.

### BACKGROUND OF THE INVENTION

Communication systems, such as cable television systems, typically include a headend section for receiving satellite signals and demodulating the signals to an intermediate frequency (IF) or baseband. The down converted signals are then modulated with radio frequency (RF) carriers and converted to an optical signal for transmission from the headend section over fiber optic cable. Optical transmitters are distributed throughout the cable system, such as at headends or hubs, for transmitting and/or forwarding optical signals, and optical receivers are provided in remote locations within the distribution system for receiving the optical signals and converting them to radio frequency (RF) signals that are further transmitted along branches of the system over coaxial cable rather than fiber optic cable. Taps are situated along the coaxial cable to tap off downstream (also referred to as “outbound” or “forward”) cable signals to subscribers of the system.

Communications as described in the preceding paragraph are generally referred to as “forward” or “downstream” communications since the signals originate at a headend and travel downstream, or in a forward direction, throughout the system-to-system subscribers. Some communication systems, particular some cable television systems, also include reverse path communications, in which subscriber equipment, e.g., set top boxes, televisions, and modems, transmit signals upstream, or in a reverse direction, to a headend or hub for processing. Communications in both directions have typically been analog in format.

Various factors influence the ability to accurately transmit and receive optical signals within an analog cable television system. As the length of fiber optic cable within a system increases, for example, signal losses also increase, thereby causing signal quality degradation. Furthermore, temperature fluctuations, which cause variation in the optical modulation index of the optical transmitter, can result in variation of the radio frequency (RF) output level of the optical receiver. Signal distortions can be caused by non-linearities in the laser and photodiode of the optical transmitter. These problems can be magnified when reverse path signals from subscriber equipment are transmitted upstream and processed by the same system equipment, such as nodes, hubs, and headend equipment.

Although employing expensive techniques can mitigate signal degradation problems, e.g., decreasing fiber lengths between optical nodes or increasing the number of hubs and nodes within a system, such techniques may prohibitively increase costs to both subscribers and service providers. Thus, what is needed is a better way to provide reliable and accurate transmission of optical signals within a cable television system.

### BRIEF DESCRIPTION OF THE DRAWINGS

FIG. 1 is a block diagram of a conventional cable television system.

FIG. 2 is an electrical block diagram of conventional headend, hub, and node equipment for use in a cable television system.

FIG. 3 is an electrical block diagram of headend, hub, and node equipment for use in a cable television system in accordance with the present invention.

FIG. 4 is a block diagram of a communications system including a node in accordance with the present invention coupling an optical branch and an RF branch.

FIG. 5 is a block diagram of the coupling node of FIG. 4 and an optical node that is suitable for use in the optical branch.

FIG. 6 is a block diagram of a second embodiment of the coupling node in accordance with the present invention for coupling two optical branches.

FIG. 7 is a block diagram of a third embodiment of the coupling node in accordance with the present invention that receives optical analog signals from one or a plurality of optical nodes.

### DETAILED DESCRIPTION OF A PREFERRED EMBODIMENT

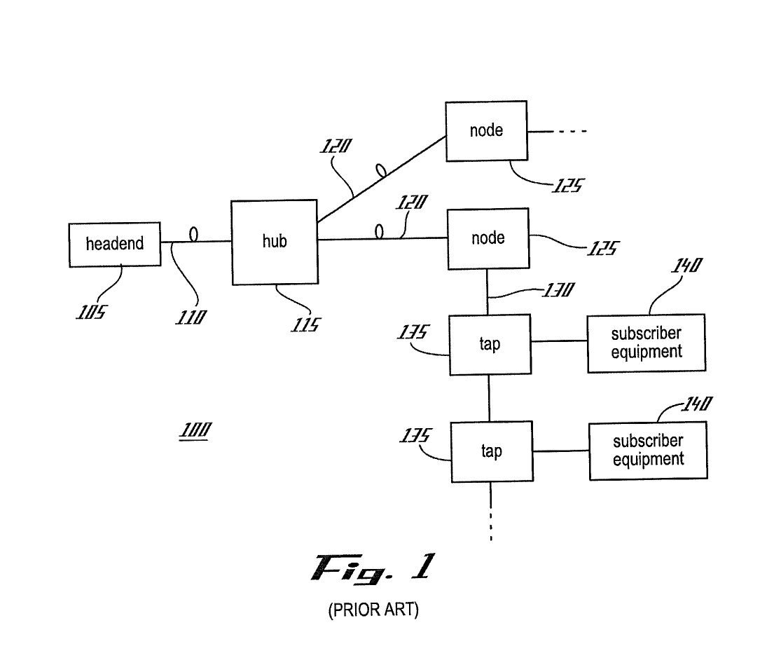

FIG. 1 shows a communications system, such as a cable television system 100, having both forward and reverse paths, i.e., having the ability to communicate downstream in the forward direction and upstream in the reverse direction. The communications system 100 includes headend equipment 105 for receiving signals from various sources and processing and/or modulating them for delivery over the communications network. The signals are then converted to cable television signals that are routed throughout the system 100 to subscriber equipment 140, such as set top decoders, televisions, or computers, located in the residences or offices of system subscribers. The headend 105 can, for instance, convert a broadband radio frequency (RF) signal to an optical signal that is transmitted over fiber optic cable 110, in which case a remotely located optical hub 115 forwards the optical signal further throughout separate branches of the system 100 over additional fiber optic communication media 120. In the different branches of the system 100, one or more optical nodes 125 convert the forward optical signals to electrical RF signals for transmission deeper into the system 100 over electrical communication media, such as coaxial cable 130. Taps 135 located along the cable 130 at various points in the distribution system split off portions of the RF signal for routing to subscriber equipment 140 coupled to subscriber drops provided at the taps 135.

The system 100, as mentioned, also has reverse transmission capability so that signals, such as data, video, or voice signals, generated by the subscriber equipment 140 can be provided back to the headend equipment 105 for processing. The reverse signals travel through the taps 135 and any nodes 125 and hubs 115 to the headend 105. In the configuration shown in FIG. 1, RF signals generated by the subscriber equipment 140 travel to the node 125, which converts the RF signals to optical signals for transmission over the fiber optic cable 120 through the hub 115 to the headend 105.

As reverse transmission equipment, such as computers, modems, televisions, and set-top units, located in subscriber homes and offices becomes more prevalent, upstream traffic increases accordingly, resulting in the need for more efficient signal processing and more complex equipment in the reverse path of communications system.

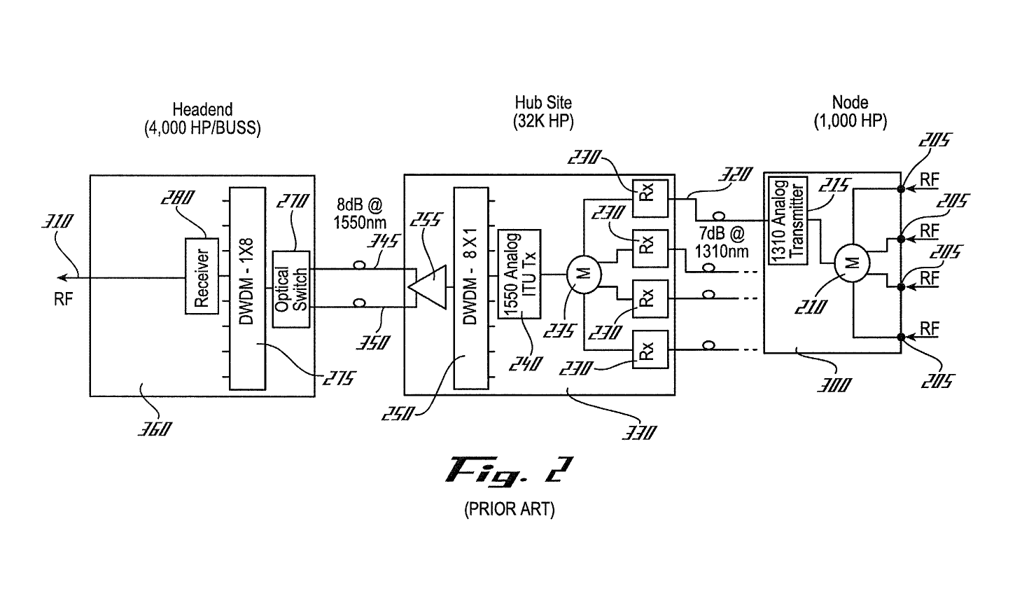

FIG. 2 shows an analog reverse path scheme that has been employed in the reverse path of communications systems, such as the system 100 of FIG. 1. In FIG. 2, the reverse path equipment portions of a node 300, a hub 330, and headend equipment 360 are depicted. The node 300 includes, for example, reverse path equipment for processing upstream signals generated at approximately 1,000 homes. More specifically, the node 300 includes four input ports 205 for receiving RF signals forwarded upstream by taps (not shown) within the system. The RF signals are provided to a signal summer 210 for combining the RF signals, and the summed analog RF signal is provided to an analog optical transmitter 215 for transmission, in a known manner, as an optical signal over a fiber optic communication channel 320. The optical signal can, for instance, be transmitted at 1310 nanometers (nm).

An upstream hub 330 includes four receiver circuits 230, each one of which can process an incoming analog optical signal from a different node 300. Each receiver circuit 230 processes the received analog optical signal to recover the RF signal, which was summed in the node 300 and subsequently provided to the node transmitter 215. The recovered RF signals from the four receiver circuits 230 are combined by a signal summer 235 within the hub 330 and then processed for transmission by an analog optical transmitter 240, which can, for example, transmit at 1550 nm. The output of the transmitter 240 is provided to an input of an eight-to-one dense wave division multiplexer (DWDM) 250, which can multiplex the optical signal together with other upstream optical signals. The multiplexed optical signal is then amplified by an optical amplifier/splitter 255 within the hub 330 for transmission over two different fiber optic cables 345, 350.

The four receiver circuits 230, the summer 235, and the analog transmitter 240 comprise only a single reverse circuit of the hub reverse path circuitry. It will be appreciated that seven other such reverse circuits can be included in the hub 330 for connection to the DWDM 250, which multiplexes eight incoming signals to provide a single output signal. As a result, the hub 330 can process reverse traffic from 32,000 homes.

According to the analog system architecture of FIG. 2, two fiber optic cables 345, 350 are coupled to inputs of reverse circuitry included within headend equipment 360. The reverse path of the headend equipment 360 includes an optical switch 270 for switching between the received analog optical signals, which are redundant, into a single signal that is coupled to the input of a one-to-eight DWDM 275 that demultiplexes the optical signal to generate eight optical outputs. Each of the eight output signals is provided to a receiver 280 (only one of which is shown) for recovering the RF signal and providing it at an output buss 310. The headend equipment 360 can, therefore, provide reverse signal traffic for up to 4,000 subscribers on each RF buss 310.

The reverse path architecture of FIG. 2 processes reverse path traffic for up to 32,000 subscribers by transmitting upstream signals in an analog format. Each hub within such architecture contains both forward and reverse circuitry associated with numerous optical nodes served by that hub, and the hubs serve as a collection point for return signals from each node.

Physically, a cable television hub may be included within a dedicated building or, more typically, within a small cabinet that may or may not be environmentally controlled and in which space is limited. Therefore, cable service providers understandably desire to limit the amount of circuitry that must be included within a hub.

An additional consideration is that cable television network reliability is of paramount importance, and increasing the number of active components in a device increases the likelihood of mechanical and electrical failure or malfunction. This is even more of a problem in devices, such as hubs, that may not be environmentally controlled, that serve a large number of cable television subscribers, and that may be located in physically distant regions. Security is also an issue, since conventional hubs are distant from a central office and are often located in areas, such as utility easements, that are easily accessible by vandals. For all of these reasons, reduction of complex circuitry at remote locations, such as within hubs and nodes of a cable television architecture, is desirable.

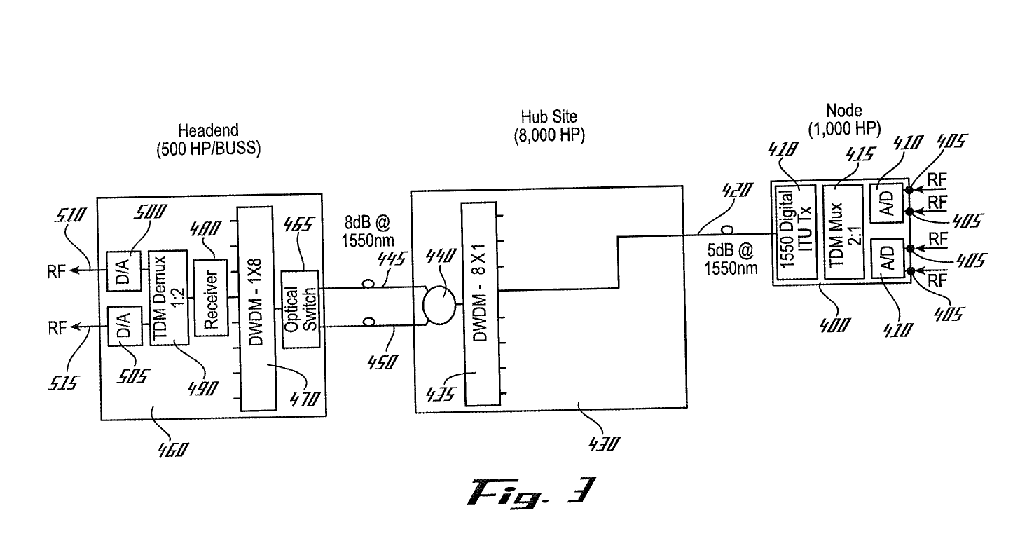

The analog architecture of FIG. 2 is less than ideal not only because of the amount of remotely located complex equipment in the reverse path, but also because the reverse transmissions occur in an analog environment. As a result, all of the problems that are associated with numerous analog transmissions over great distances (detailed in the Background of the Invention hereinabove) are present in the analog architecture of FIG. 2. Additionally, the architecture of FIG. 2 is bandwidth restrictive because approximately 4,000 homes share a single buss at multiple locations within the reverse path architecture. These problems are mitigated in the reverse path cable television architecture shown in FIG. 3.

FIG. 3 illustrates reverse path circuitry included in nodes, hubs, and headend equipment of a communications system in accordance with the present invention. As shown, an optical node 400 includes a reverse path circuit comprising four analog RF input ports 405 for receiving reverse transmissions from subscriber equipment. The node 400 further includes two or more analog-to-digital (A/D) converters 410, each of which is coupled to two input ports 405 for receiving two RF signals, which are combined (either inside or outside of the A/D converter 410) prior to digital conversion. In this manner, the node 400 can receive RF signals from approximately 1,000 subscribers.

Each A/D converter 410 converts the combined analog electrical signals to a single digital electrical signal that is provided to an input of an N-to-one time division multiplexer 415, where N can, for example, equal two (2). The multiplexer 415 interleaves the incoming digital electrical signals, such as by bits, bytes, or data packets, to provide a single digital bit stream which is digitally optically transmitted by an optical transmitter 418, which can, for instance, transmit over a fiber optic cable 420 at 1550 nm.

Digital optical transmitters and receivers are disclosed in detail in commonly assigned U.S. patent application Ser. No. 09/102,344 (Attorney's Docket No. A-4749) to Farhan et al., entitled “Digital Optical Transmitter” and filed on Jun. 22, 1998, the teachings of which are hereby incorporated by reference.

The digital optical signal is received by reverse path circuitry included in the hub 430 and routed directly to an input of an N-to-one DWDM 435, where N can be eight (8). When N=8, the DWDM 435 can also receive seven other digital optical signals from seven other nodes so that the hub 430 is capable of processing reverse signals from a total of, for example, 8,000 subscribers. The DWDM 435 multiplexes the signals to generate a single digital optical output, which can optionally be split by a passive optical splitter 440 into two signals, each of which is transported over a different fiber optic cable 445, 450 for redundancy. Diversity within the system is not, however, necessary.

When redundancy is provided, the two fiber optic cables 445, 450 are coupled to reverse path inputs of headend equipment 460. The headend equipment 460 includes an optical switch 465 that switches between the two received digital optical signals into a single digital optical signal that is coupled to the input of a one-to-N DWDM 470, where N can be equal to eight (8). When N=8, the DWDM 470 demultiplexes the digital optical signal to generate eight digital optical signals at its eight outputs. Each output of the DWDM 470 is coupled to a receiver 480 (only one of which is shown) for converting the digital optical signal to a digital electrical signal and then to a time division demultiplexer 490 for splitting the electrical signal into two digital electrical signals that are equivalent to the two digital electrical signals that were previously generated by the A/D converters 410 of the node 400. Each demultiplexed signal is provided to a digital-to-analog (D/A) converter 500, which converts the digital electrical signal to an analog electrical signal for transmission over an RF buss 510, 515.

It will be appreciated that the headend equipment 460 can include a receiver, demultiplexer, and two D/A converters for each of the eight DWDM outputs and that, according to the circuitry depicted in FIG. 3, each RF output buss 510, 515 can provide reverse path transmissions from 500 homes, or subscribers.

It will be appreciated by one of ordinary skill in the art that the reverse path architecture of FIG. 3 can, according to the present invention, be configured to use different numbers of elements and different types of elements without departing from the teachings herein. For example, the node 400 could include different numbers of A/D converters 410, and the time division multiplexing need not be two-to-one. Additionally, the DWDMs 435, 470 could process various numbers of signals, and diversity could be entirely lacking in the reverse path architecture between the hub 430 and the headend 460. Alternatively, a greater number of diverse paths could be employed, if desired. It will be further appreciated that variations within the reverse path architecture of the present invention could dictate that the nodes 400, hubs 430, and headend equipment 460 process signals from a greater number or a lesser number of subscriber homes without impacting the advantages of the reverse path architecture described herein.

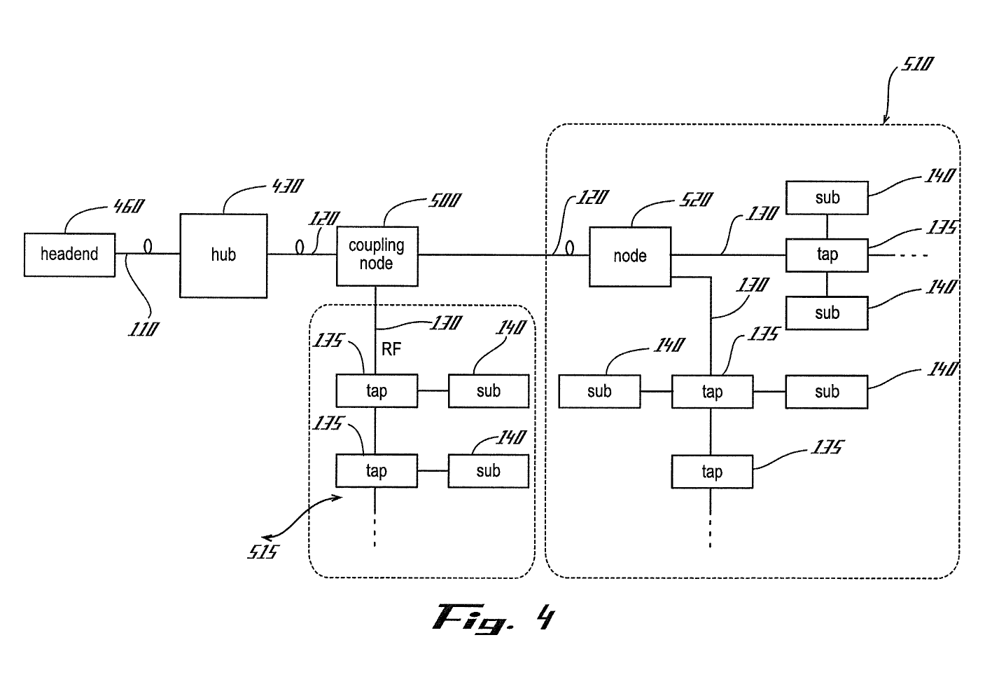

FIG. 4 is a block diagram of a communications system including a coupling node 500 in accordance with the present invention for coupling an optical branch 510 and an RF branch 515. As operators continue to pull optical fiber closer to the subscriber's premises, conventional communications equipment and architectures need to be upgraded. An example of one such upgrade is shown in FIG. 4. The RF branch 515 may be an existing branch for servicing existing subscribers. The optical branch 510 may be a new development where the operator has pulled optical fiber either to the subscriber's home or to the curb. Conventionally, the operator would run optical fiber from the subscriber's premises in the optical branch 510 back to the hub 430 (FIG. 3). More specifically, the RF branch 515 and the optical branch 510 are not combined in conventional communications systems. In accordance with the present invention, however, the coupling node 500 receives optical digital signals from the optical branch 510 and analog RF signals from the RF branch 515 and combines these signals. A combined optical digital signal is then provided to the hub 430 for multiplexing with additional branches of the system. Significantly, the operator does not have to run a separate optical fiber path to accommodate the newly developed or upgraded optical branch 510.

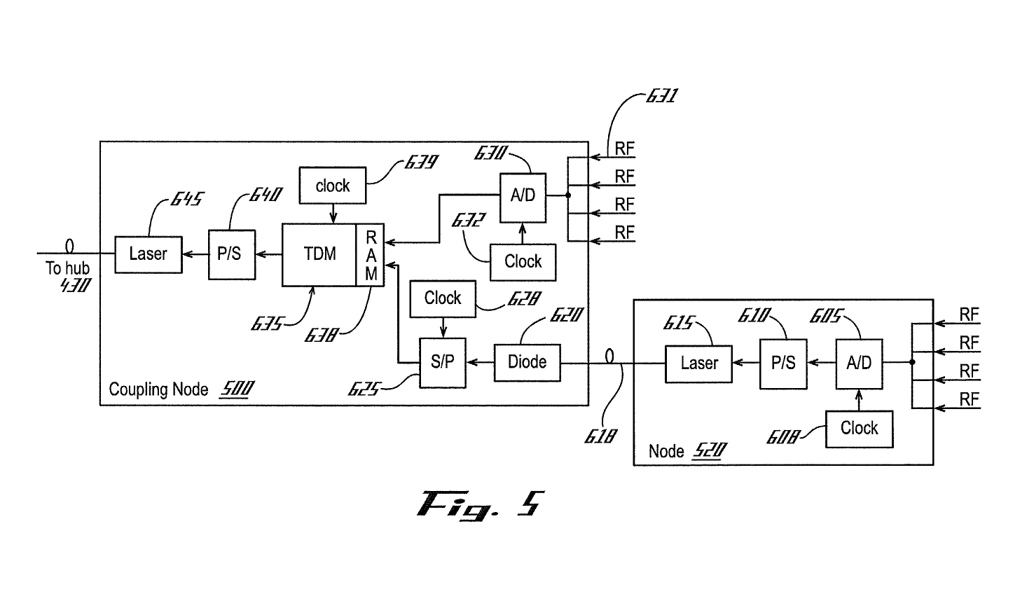

FIG. 5 is a block diagram of the coupling node 500 of FIG. 4 and a digital optical node 520 that is suitable for use in the optical branch 510. Accordingly, an A/D converter 605 receives analog RF input signals from at least one RF input port. It will be appreciated that the RF signals received from downstream subscribers are electrically combined, either internally or externally, prior to digitization by the A/D converter 605. The A/D converter 605 samples the RF signals clocked via clock 608 in a known manner, for example, 12-bits at 100 Megabits per second (Mb/s). The 12-bit parallel digital output is provided to a parallel-to-serial (P/S) converter 610 for framing and encoding to provide a framed serial output. A laser 615 converts the serial digital signal into an optical digital signal for transport via an optical fiber 618 to the coupling node 500 located further upstream.

The coupling node 500 receives the optical digital signal and converts the signal to an electrical digital signal via a photodiode 620. A serial-to-parallel (S/P) converter 625 that is controlled by clock 628, which is at the same clock rate as clock 608, converts the signal back to a parallel digital signal using the framing overhead bits.

Also included in the coupling node 500 is an A/D converter 630 that receives analog RF signals from at least one RF input port. The A/D converter 630 is coupled via coaxial cable 631 to the RF branch 515 (FIG. 4). The A/D converter 630 that is controlled by clock 632, which is at the clock rate equal to clock 608, samples the RF signals and provides parallel digital signals. After digitization, the digital signals from the RF branch 515 are summed or multiplexed with the electrical digital signals from the optical branch 510 via, for example, a time division multiplexer (TDM) 635. Included in the TDM 635 can be, for example, a first-in first-out (FIFO) dual port random access memory (RAM) circuit 638 for receiving the two parallel digital signals and ensuring proper multiplexing. An optional clock 639 can be included that can be controlled by clock 608, for example. The TDM clock 639 controls the multiplexing in the event that clocks 608, 628, or 632 become unsynchronized. It will be appreciated, however, that if the sampling rate is high enough, such as 100 Mb/s, a TDM clock may be unnecessary.

A parallel-to-serial (P/S) converter 640 subsequently converts the combined digital signals to a serial signal; thereafter, the serial signal is provided to a laser 645 for optical conversion. The combined optical signals (i.e., the RF signals received by the RF branch 515 and the optical signals received by the optical branch 510) are then provided to the hub 430 (FIG. 3) for further multiplexing with additional nodes providing signals from additional RF or optical branches that are ultimately routed to the headend 460 (FIG. 3) for demultiplexing and further processing as described hereinabove.

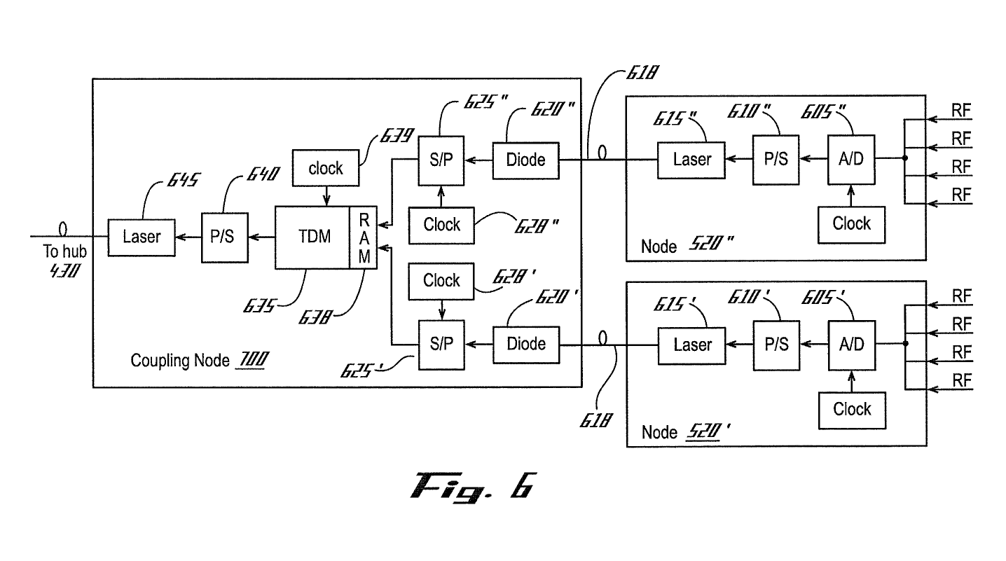

FIG. 6 is a block diagram of a second embodiment of the coupling node 700 in accordance with the present invention for coupling two optical branches. Accordingly, two digital optical nodes 520′, 520″ receive analog RF signals from two separate and distinct geographic branches. The RF signals are digitized, serialized, and converted to optical digital signals as described hereinabove. The optical digital signals from each optical node 520′, 520″ are received at separate input ports of the coupling node 700. A first photodiode 620′ receives the optical digital signal from the optical node 520′ and converts the optical digital signal into an electrical digital signal. A first S/P converter 625′ converts the electrical digital signal to a parallel digital signal that is controlled by a first clock 628′. A second photodiode 620″ receives the optical digital signal from the optical node 520″ and converts the optical digital signal into an electrical digital signal. A second S/P converter 625″ converts the electrical digital signal to a parallel digital signal that is control by a second clock 628″. The two parallel signals are subsequently provided to the RAM circuit 638 for queuing and the TDM 635 for multiplexing. The P/S converter 640 serializes the combined digital signal and the laser 645 converts the serial signal into a combined optical digital signal for transport to the hub 430 (FIG. 3) for further multiplexing with additional RF or optical branches.

It will be appreciated that the coupling nodes 500, 700 as illustrated show combining the signals from two distinct regions. The coupling node 500 combines the analog RF signals and optical digital signals and the coupling node 700 combines two optical digital signals. It will be appreciated, however, that more branches can be added, either RF or optical, so long as the coupling node is altered to receive additional signals. For example, another A/D converter can be added and the multiplexer changed to a 3:1 multiplexer to coupling node 500 to receive RF signals from an additional RF branch. Similarly, coupling node 700 can be altered to include another diode and S/P converter to receive optical digital signals from an additional optical branch. Moreover, the digital optical node can be altered to receive optical signals from a digital optical node located further downstream in a “daisy chained” fiber branch by adding components similar to the components included in the coupling node.

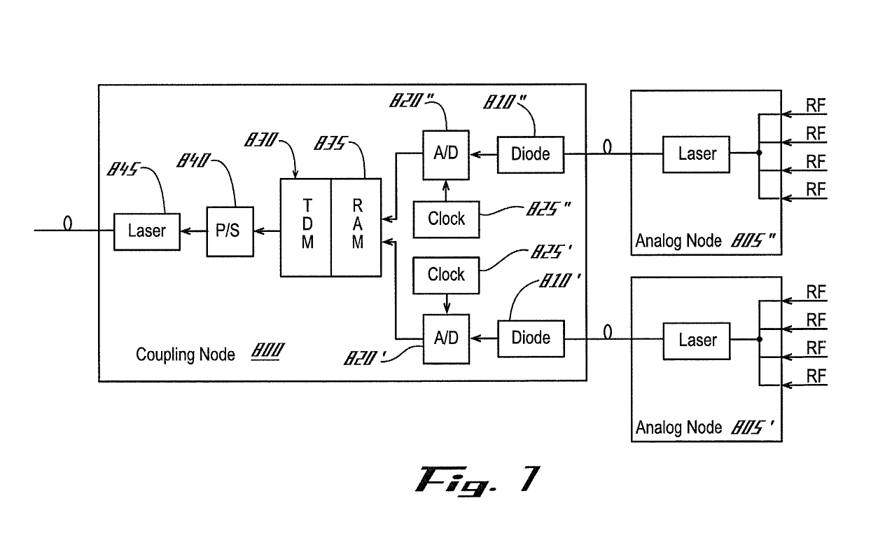

Alternatively, a third embodiment of the present invention is shown illustrated in FIG. 7. FIG. 7 is a block diagram of a coupling node 800 that receives optical analog signals from one or a plurality of optical nodes 805′, 805″. The optical nodes 805 receive analog RF signals from a plurality of subscriber equipment and provide an optical analog signal in a known manner. The coupling node 800 converts the optical analog signals to an electrical analog signal via diodes 810′, 810″. A/D converters 820′, 820″ that are clocked with clocks 825′, 825″ at a predetermined sampling rate subsequently digitize the signals. It will be appreciated that the A/D converters 820 and clocks 825 can either be included as stand alone components or assembled in a removable module. Subsequently, a TDM 830 with a FIFO memory module 835 receives the two digital streams and multiplexes them to provide a single digital stream. A P/S converter 840 serializes the combined digital stream and a laser 845 converts the digital stream into optical digital signals. The optical digital signal can then be transported upstream to hub 430 and combined with additional optical digital signals received from additional RF branches or fiber branches. In this manner, an operator with existing optical analog nodes is able to continue using the existing nodes and, instead of running separate optical fibers from the existing nodes to the hub for multiplexing, a coupling node can be inserted into the system to digitize and combine one or more optical analog signals. Significantly, this allows an operator flexibility and cost savings when upgrading the system.

In summary, according to the present invention, a coupling node can be used to combine optical digital signals, optical analog signals, and/or analog RF signals from a plurality of optical nodes for transport to the totally passive hub. As a result, optical branches can be added to existing RF branches in different geographic regions. Additionally, operators can replace active communications devices, such as amplifiers, with the passive optical nodes to eliminate costly repairs.

What is claimed is:

1. In a communications system including a headend that provides video and data to a plurality of subscriber equipment via a fiber-to-the-home (FTTH) network, the communications system including a plurality of digital optical nodes for connecting a plurality of fiber branches to the headend, the communications system including a reverse path for transmitting combined RF signals from the plurality of subscriber equipment to the headend via the FTTH network, the reverse path comprising:
a plurality of digital optical nodes, each digital optical node coupled to one of the plurality of fiber branches for converting RF signals into a combined digital signal and for providing an optical digital signal in accordance with the RF signals; and
a coupling node coupled to the plurality of digital optical nodes for receiving the optical digital signal associated with each of the plurality of digital optical nodes and for providing a combined optical digital signal for transport via an optical fiber to the headend.

2. The communications system of claim 1, wherein each of the plurality of digital optical nodes comprises:
a plurality of input ports for receiving and combining the RF signals from the plurality of subscriber equipment located in a fiber branch;
an analog-to-digital (A/D) converter for converting the combined RF signals into a parallel digital signal;
a parallel-to-serial (P/S) converter for serializing the parallel digital signal; and
a laser for generating the optical digital signal in accordance with the serialized digital signal.

3. The communications system of claim 2, each of the plurality of digital optical nodes further comprise:
an A/D clock having a clock rate for controlling a sampling rate associated with the A/D converter.

4. The communications system of claim 3, the coupling node comprising:
a plurality of diodes, each diode for receiving the optical digital signal from one of the plurality of digital optical nodes and for converting the optical digital signal to an electrical digital signal;
a plurality of serial-to-parallel (S/P) converters each coupled to a diode for providing a parallel electrical digital signal;
a multiplexer for combining the parallel electrical digital signal from the plurality of S/P converters into a combined digital signal;
a P/S converter for serializing the combined digital signal and for providing a serial combined digital signal; and
a laser for generating the combined optical digital signal in accordance with the optical digital signal associated with each of the plurality of digital optical nodes.

5. The communications system of claim 4, the coupling node further comprising:
an S/P clock coupled to each S/P converter having an equivalent clock rate with the clock rate associated with the respective digital optical node.

6. The communications system of claim 5, the coupling node further comprising:
a TDM clock controlling the multiplexer, wherein the TDM clock is controlled by one of the A/D clocks associated with one of the plurality of digital optical nodes.

7. The communications system of claim 4, the coupling node further comprising:
a first-in first-out (FIFO) memory buffer coupled to the plurality of S/P converters for receiving the parallel electrical digital signals and for providing a FIFO signal to the multiplexer.

8. The communications system of claim 4, the reverse path further comprising:
a hub coupled to the coupling node, the hub comprising:
a dense wave division multiplexer (DWDM) for multiplexing the combined optical digital signal with additional combined optical digital signals from additional coupling nodes to generate one or more multiplexed digital optical signals at a hub output.

9. The communications system of claim 8, wherein the headend comprises:
a dense wave division demultiplexer for demultiplexing the one or more multiplexed digital optical signals;
at least one receiver coupled to an output of the dense wave division demultiplexer for receiving one of the demultiplexed digital optical signals and for recovering therefrom a second electrical digital signal in accordance with the parallel electrical digital signal associated with one of the coupling nodes;
a demultiplexer coupled to the at least one receiver for demultiplexing the second electrical digital signal to provide demultiplexed digital signals in accordance with the combined digital signals associated with the plurality of digital optical nodes; and
a plurality of digital-to-analog converters each for converting a demultiplexed digital signal to the RF signals associated with one of the plurality of fiber branches.

10. In a communications system including a headend that provides video and data to a plurality of subscriber equipment via a hybrid fiber/coax (HFC) network that includes a plurality of RF and fiber branches, the communications system including a reverse path for transmitting combined RF signals from the plurality of subscriber equipment to the headend via the HFC network, the reverse path comprising:
a digital optical node coupled to a fiber branch for converting first RF signals into a first combined digital signal and for providing an optical digital signal in accordance with the first RF signals; and
a coupling node coupled to the digital optical node and an RF branch for receiving the optical digital signal and second RF signals, respectively, the coupling node for converting the optical digital signal into an electrical digital signal and converting the second RF signals into a combined second digital signal, combining the electrical digital signal and the combined second digital signal into a combined optical digital signal, and transporting the combined optical digital signal via an optical fiber to the headend.

11. The communications system of claim 10, wherein the digital optical node comprises:
a plurality of input ports for receiving and combining the first RF signals from the plurality of subscriber equipment located in the fiber branch;
an analog-to-digital (A/D) converter for converting the combined first RF signals into a parallel digital signal;
a parallel-to-serial (P/S) converter for serializing the parallel digital signal; and
a laser for generating the optical digital signal in accordance with the serialized digital signal.

12. The communications system of claim 11, the digital optical node further comprising:
an A/D clock having a clock rate for controlling a sampling rate associated with the A/D converter.

13. The communications system of claim 12, the coupling node comprising:
a diode for receiving the optical digital signal and for converting the optical digital signal into the electrical digital signal;
a serial-to-parallel (S/P) converter coupled to the diode for providing a parallel digital signal;
a plurality of input ports for receiving and combining the second RF signals from the plurality of subscriber equipment located in the RF branch;
an A/D converter for digitizing the combined second RF signals to provide the combined second digital signal;
a multiplexer coupled to the S/P converter and the A/D converter for combining the parallel electrical digital signal and the combined second digital signal into a multiplexed digital signal;
a P/S converter for serializing the multiplexed digital signal and for providing a serial multiplexed digital signal; and
a laser for converting the serial multiplexed digital signal into the combined optical digital signal.

14. The communications system of claim 13, the coupling node further comprising:
an S/P clock coupled to the S/P converter having an equivalent clock rate with the clock rate associated with the digital optical node.

15. The communications system of claim 14, the coupling node further comprising:
a TDM clock controlling the multiplexer, wherein the TDM clock is controlled by the A/D clock.

16. The communications system of claim 13, the coupling node further comprising:
a FIFO memory buffer coupled to the S/P converter and the A/D converter for receiving the parallel electrical digital signal and the combined second digital signal and for providing a FIFO signal to the multiplexer.

17. The communications system of claim 13, the reverse path further comprising:
a hub coupled to the coupling node, the hub comprising:
a dense wave division multiplexer (DWDM) for multiplexing the combined optical digital signal with additional combined optical digital signals from additional coupling nodes to generate one or more multiplexed digital optical signals at a hub output.

18. The communications system of claim 17, wherein the headend comprises:
a dense wave division demultiplexer for demultiplexing the one or more multiplexed digital optical signals;
at least one receiver coupled to an output of the dense wave division demultiplexer for receiving one of the demultiplexed digital optical signals and for recovering therefrom a second electrical digital signal in accordance with the multiplexed digital signal associated with one of the coupling nodes;
a demultiplexer coupled to the at least one receiver for demultiplexing the multiplexed digital signal to provide demultiplexed digital signals in accordance with the parallel electrical digital signal and the combined second RF signal; and
a plurality of D/A converters each for converting one of the parallel electrical digital signal into the first RF signals and the combined second RF signals into the second RF signals.

19. In a communications system including a headend that provides video and data to a plurality of subscriber equipment via an HFC network, the communications system including a plurality of optical nodes for connecting a plurality of fiber branches to the headend, the communications system including a reverse path for transmitting combined RF signals from the plurality of subscriber equipment to the headend via the HFC network, the reverse path comprising:
a plurality of optical nodes, each optical node for receiving RF signals from the plurality of subscriber equipment and for providing an optical signal; and
a coupling node coupled to the plurality of optical nodes for receiving the optical signal associated with each of the plurality of optical nodes and for providing a combined optical digital signal for transport via an optical fiber to the headend.

20. The communications system of claim 19, wherein the coupling node comprises:
a plurality of diodes, each diode for receiving the optical signal from one of the plurality of optical nodes and for converting the optical signal to an electrical signal;
a plurality of A/D converters each for converting the electrical signal to a digital signal;
a multiplexer for combining the digital signal from the plurality of A/D converters into a combined digital signal;
a P/S converter for serializing the combined digital signal and for providing a combined serial digital signal; and
a laser for generating the combined optical digital signal in accordance with the combined serial digital signal.

21. The communications system of claim 20, wherein the reverse path further comprises:
a hub coupled to the coupling node, the hub comprising:
a dense wave division multiplexer (DWDM) for multiplexing the combined optical digital signal with additional combined optical digital signals from additional coupling nodes to generate one or more multiplexed digital optical signals at a hub output.

22. The communications system of claim 21, wherein the headend comprises:
a dense wave division demultiplexer for demultiplexing the one or more multiplexed digital optical signals;
at least one receiver coupled to an output of the dense wave division demultiplexer for receiving one of the demultiplexed digital optical signals and for recovering therefrom an electrical digital signal in accordance with the combined digital signal associated with one of the coupling nodes;
a demultiplexer coupled to the at least one receiver for demultiplexing the electrical digital signal to provide demultiplexed digital signals in accordance with the digital signal associated with one of the plurality of A/D converters in the coupling node; and
a plurality of D/A converters each for converting a demultiplexed digital signal to the RF signals associated with one of the plurality of optical nodes.
